(19) United States
(12) Patent Application Publication
(10) Pub. No.: US 2004/0015609 A1
(43) Pub. Date: Jan. 22, 2004

(54) Method and system for conversion of message formats in a pervasive embedded network environment

(75) Inventors: William A. Brown, Raleigh, NC (US); Richard William Muirhead, Tyler, TX (US); Francis Xavier Reddington, Sarasota, FL (US)

Correspondence Address: Darcell Walker, Suite 250, 9301 Southwest Freeway, Houston, TX, 77074, US

(73) Assignee: INTERNATIONAL BUSINESS MACHINES CORPORATION, ARMONK, NY

(21) Appl. No.: 10/199,588

(22) Filed: Jul. 18, 2002

(51) Int. Cl. G06F 15/16

(52) U.S. Cl. 709/246

(57) ABSTRACT

The present invention provides a method and system to convert messages transmitted in a network to a message format that is CAL compliant. In this invention, data conversion points along the network perform data conversions of messages transmitted on the network. These conversion points, known as conversion nodes, can convert routines for the common communication protocols that can convert a message in one protocol to a message in another communication protocol. In the method of the present invention, each time a message is transmitted on the network, the message will pass through one of the conversion nodes before arriving at the state manager. At the conversion node, the message protocol type is identified and the appropriate conversion routine to convert that message format into the compatible format of the destination location of the message. This destination location is normally the state manager. The conversion nodes can be located anywhere along the network, but the most logical at a location where the messages converge, which is near the state manager.

### FIELD OF THE INVENTION

This invention relates to a method and system for communicating between devices connected to a network and in particular to a method and system for transforming messages sent from and to devices on the network into a common message format for communication with devices on a network which monitors, stores and manages the operational statuses of devices that operate on that network.

### BACKGROUND OF THE INVENTION

Automation systems are used to control the behavior of an environment such as an industrial plant, an office building or a residential dwelling. Currently there is an increasing trend to automate various activities and task in our society. Industries such as the banking industry, the automotive industry, the oil and refining industry and transportation industry use computers and automation to control machines and other various devices during the performance of many tasks and processes. The application of automation control systems has expanded from large industries to small businesses and residential homes.

Home automation systems, or home management systems as they are sometimes called, commonly provide for control of lighting, heating and air conditioning, window shades or curtains, pool heaters and filtration systems, lawn sprinklers, ornamental fountains, audio/visual equipment, and other appliances. Home automation systems are frequently integrated with a home security system so that when a fire alarm is raised, for example, internal and external lights will be turned on. Security systems frequently include lighting control and other types of home automation as an option. Many larger homes incorporate a home theater that requires a certain amount of automation for convenient operation and this automation is often extended to other parts of the dwelling. In farms, the automation system will also control outbuilding heating and lighting and warn of abnormal conditions in automated feeding machinery and other equipment.

One form of automation system includes a central control unit that monitors environmental sensors and inputs from user controls and maintains a schedule of preprogrammed time-of-day and day-of-the week events. Inputs to the central control are provided by dedicated low-voltage wiring, for example, from door and window sensors, signals carried on power lines, RF signals, signals on existing telephone wiring and, occasionally, optical signals. The central control unit is controlled by a program that is either specifically built for the particular installation or a general-purpose program with a user interface that allows the owner or a technician employed by the owner to make certain types of modifications. The interfaces to these programs can be anything from strings of digits entered on standard touch-tone keypads, for example, Home Automation Inc.'s Omni Automation and Security System, to graphical user interfaces, for example, the Molex “Choices” software.

The communication between the central control unit and various devices can be through a variety of protocols. The Echelon Corporation has built home automation and industrial control apparatus based on a signaling protocol they refer to as LonWorks that uses a network of nodes each of which has one or more microprocessors. The system is designed to operate in a “cooperative computing” environment in which the individual nodes maintain their own programs. Programming of the individual nodes can be done by downloading new software from a temporarily attached lap top computer or by downloading software over the LonWorks network. A similar approach has been taken by CEBus and has been used in many custom installations for larger homes and office buildings. While such systems eliminate the central control unit, modifying the software still requires the use of a PC-based system and usually requires the user to acquire relatively expensive hardware and software and become proficient in the use of PC-based software.

The latest internationally accepted standard for residential communication is the Consumer Electronics Bus (CEBus). The Media used in a CEBus Network topology can vary between power-line wiring (PL), telephone wiring (TP twisted-pair), coaxial cable (CX), RF (radio frequency) and the like. It provides the standard for creating products and devices to communicate with each other, and should build intelligence into homes or any physical or virtual facility with smart products (aggregation of smart devices) in anticipating tomorrow's consumer needs. Though the intent of the original specification was directed at the residential market, the inventions disclosed here by its three inventors have envisioned a much more extensive application uses. The consumer can be any person, a firm, government agency, whatever or whomever has a need to communicate to smart devices.

The official name for CEBus standard is ANSI/EIA 600. At the core of the standard are the CAL (Common Application Language) and the Application Layer. It provides the basis of the interoperability between CEBus compliant devices and a transport independent version (Generic CAL) (Generic CAL) ANSI/739 that an integral part of the Home PnP (Plug and Play) ANSI/721 specification (which defines how networked products of various manufactures achieve interoperability regardless of the communication protocol used (CEBus, X-10, RS-232, IEEE-1934, TCP/IP etc.)

The devices that utilize these standards contain context data structures. Each CAL Context is a predefined data structure built from reusable objects, and represents a common consumer product function such as a tuner, time or temperature sensor. These context data structures are defined in a set of subsystems definitions that represent industry standard guidelines that define the behavior of the device, which is necessary to enable products to correctly use the subsystem models.

CEBus is a connectionless service protocol. In this protocol, no Session layer functions are used. The Presentation layer is not necessary because there is no requirement for conversion of data to or from a format used the Application Layer (the Layer in the CEBus is the CAL Language interpreter). As a result, data is expected to be in the proper format before it reaches the CAL Language interpreter.

It is desirable to provide an automation system that has a central control unit that can enable various devices on the same system to communicate with each other. In addition it is desirable to have a standard communication format for messages transmitted on the network. It is another desire of the present invention to provide a method and system that can convert messages of different formats into a common format for messages transmitted on the network.

### SUMMARY OF THE INVENTION

It is an objective of the present invention to provide a method that can enable various devices having various communication protocols to communicate with each other on the same network.

It is a second objective of the present invention to provide a method that can convert messages of different formats into a common format for messages transmitted on the network.

It is a third objective of the present invention to ensure that messages transmitted on a network containing a CEBus connectionless protocol be in the proper message format before the message reaches the CAL Language interpreter.

It is a fourth objective of the present invention to provide a method and system to capture packets of data at logical network points and transform these packets into proper context structures required in the CAL compliant message format.

The present invention provides a method and system to convert messages transmitted in a network to a message format that is CAL compliant. The present invention is implemented in the context of a system that monitors and manages the statuses of devices that are connected to and operate in network environment. The monitoring and management operations occur in a process referred to as the state manager that is positioned in a centralized location on the network. As a result, messages transmitted on the network pass through this state manager. This centralized system configuration provides the devices, products and smart applications on the network a common interface to inquire and use any derived intelligence in applying this acquired information. However, the state manager operates on a specific communication protocol. Many of the devices connected on the network operate on other communication protocols. Therefore, message conversion mechanisms must be in place to ensure that all devices on the network can communicate with the state manager.

In this invention, data conversion points along the network perform data conversions of messages transmitted on the network. These conversion points, known as conversion nodes, can convert routines for the common communication protocols that can convert a message in one protocol to a message in another communication protocol. In the method of the present invention, each time a message is transmitted on the network, the message will pass through one of the conversion nodes before arriving at the state manager. At the conversion node, the message protocol type is identified and the appropriate conversion routine to convert that message format into the compatible format of the destination location of the message. This destination location is normally the state manager. The conversion nodes can be located anywhere along the network, but the most logical at a location where the messages converge, which is near the state manager.

### BRIEF DESCRIPTION OF THE DRAWINGS

FIG. 1 is an illustration of a network that monitors and manages the statuses of devices that are connected to and operate on the network.

FIG. 2 is a configuration of two devices connected in a network with a CEBus communication protocol.

FIG. 3 illustrates a state diagram showing the state management of a CAL message compliant device.

FIG. 4 is an illustration of a CEBus model.

FIG. 5a is an illustration of the ISO System model that represents a conventional standard of communication.

FIG. 5b shows the internal structure of the CEBus communication model.

FIG. 6 is an illustration of an application of the present invention in the context of a network that monitors and manages the statuses of devices that are connected to and operate on the network.

FIG. 7 is a flow diagram of the steps in the method of the present invention when messages are transmitted to a state manager.

FIG. 8 is a flow diagram of the steps in the method of the present invention when messages are transmitted from a state manager to a device on the network.

### DETAILED DESCRIPTION OF THE INVENTION

The present invention provides a method and system to convert messages transmitted on a network to a form that ensures compatibility with the components of the network. In order to clearly illustrate the techniques in this invention, the description of this invention will be in the context of a network application in a physical facility. However, the application of this invention encompasses applications in addition to the physical facility environment described herein. As previously mentioned, the present invention provides works within the context of a method and system to monitor and manage the statuses of devices that operate in a network from a central location. The standard communication protocol can be the Consumer Electronics Bus (CEBus).

The communication with all compliant devices in this CEBus Network topology can use several mediums such as; power-line wiring (PL), telephone wiring (TP twisted-pair), coaxial cable (CX), RF (radio frequency) and other similar transmission mediums. The present invention provides the mechanisms to ensure a standard for communication between components on a network. The present invention has applications in various segments of society, which include individual consumers, a business, a firm, or governmental agency.

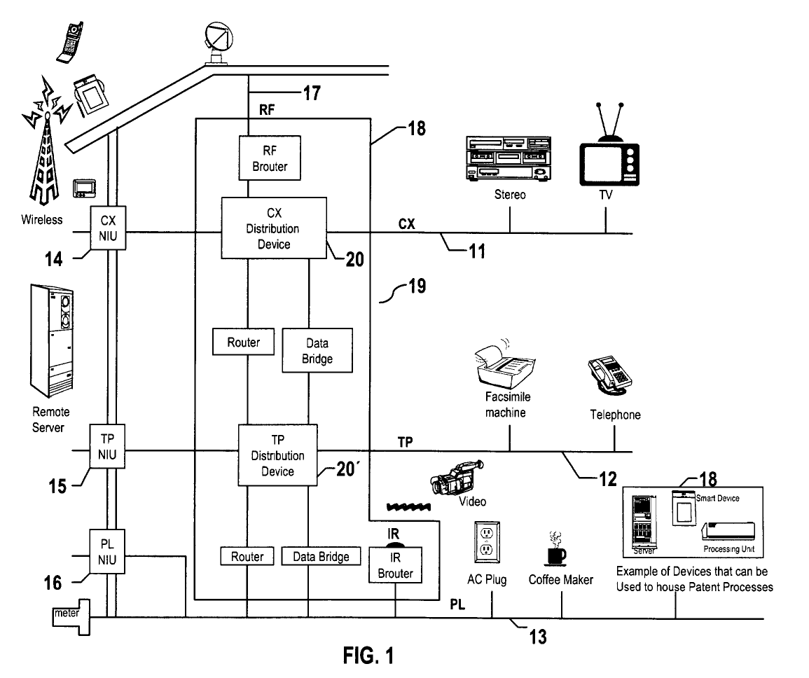

FIG. 1 is a configuration of components in the system that is the typical application for the method and system of the present invention. In this configuration lines 11, 12 and 13 are various ways that information and energy can enter a facility to enable operations of the devices in the facility. Line 11 represents communications over a coaxial cable through a device such as a television set. Line 12 represents communications over twisted pair cables through a device such as a telephone. Line 13 represents the supply of energy through a standard power line wired into the facility to operate devices and appliances in the facility such as a coffee maker. These communication lines are physical and therefore have a physical entry into the facility. The physical entry points for the coaxial cable, twisted pair and power lines are represented by NIU boxes 14, 15, and 16 respectively. Also shown is an input medium using radio frequencies (RF) 17. Devices that communicate through this medium are remote devices/wireless devices that include devices such as cellular telephones. In the present invention, there would be a status of each device in facility regardless of the manner in which the device is powered or the manner in which the device communicates. The center of activity is the state manager 18, which is a process that receives status information from various types of devices. This state manager 18 captures status information for the various devices and coordinates communications between the various devices in the facility. In addition, this state manager, using industry standard format, provides persistence to a data store and can transmit data to any device in the facility. Section 19 illustrates bridges and routes that provide communication links between the incoming information lines (11, 12, and 13), the distribution devices 20 and 20′ and the devices As previously mentioned, the devices that utilize the CEBus standards contain context data structures. Each CAL Context is a predefined data structure built from reusable objects, and represents a common consumer product function such as a tuner, time or temperature sensor. These context data structures are defined in set of subsystems definitions that represent industry standard guidelines that define the behavior of the device. These guidelines are necessary to enable products to correctly use the subsystem models.

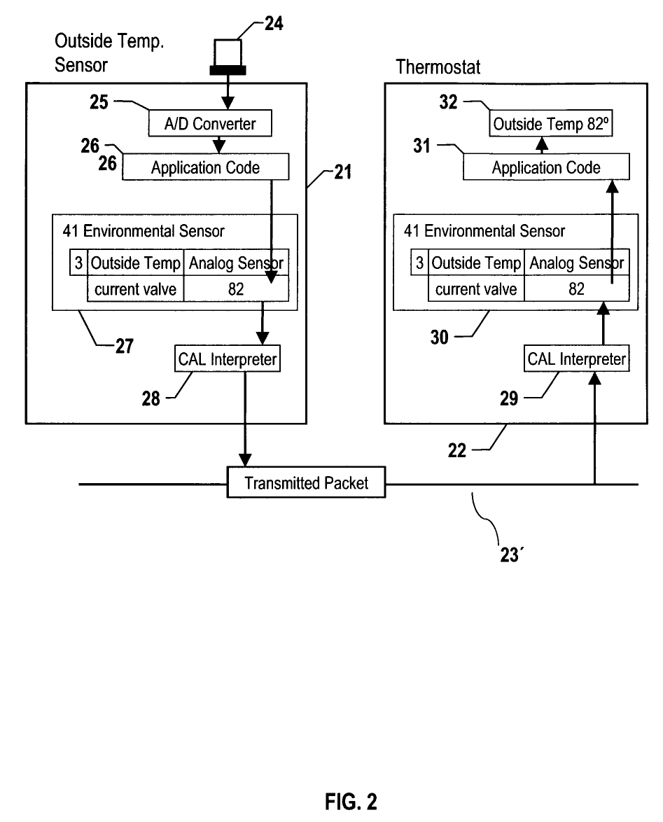

FIG. 2 shows two different devices that communicate with each other using this CEBus network topology standard. One device is an outside temperature sensor 21, the other being a thermostat 22. Both devices store within their solid-state memory context data structures, in which contain different attributes and their values. The sensor and thermostat can communicate with the state manager 18 over a transmission bus 23. The state manager 18 can also communicate with the thermostat over the bus. The bus 23 is where there must be a common format for all transmitted data packets 23′. The outside temperature system comprises an actual sensor 24 that detects the current outside temperature. This sensor sends an analog signal of the measured to temperature to an A/D converter 25 that converts the signal to digital form. The application code box 26 processes this signal and sends it to a display 27. This application code box 26 contains software that can exist on any device. The use of a Consumer Electronic Bus (CEBus) protocol allows for application software to reside on each device. Box 27 displays the current temperature measured by the sensor 24. The Common Application Language (CAL) interpreter 28 receives this measurement and transmits the information via the transmission bus 23 to the state manager 18. The CAL interpreter parses and understands the message format and the transmitted packet represents a communication link between the two devices. This information would be recorded for the temperature sensor in the storage section each time the temperature sensor detected a change in temperature. The internal thermostat 22 contains a Common Application Language (CAL) interpreter 29 to facilitate communication via the transmission bus 23 with the central control section. Also contained in the thermostat is a temperature display 30 similar to the display 27 in the outside temperature sensor 21. Application code 31 puts the temperature information in a form for the temperature display 32.

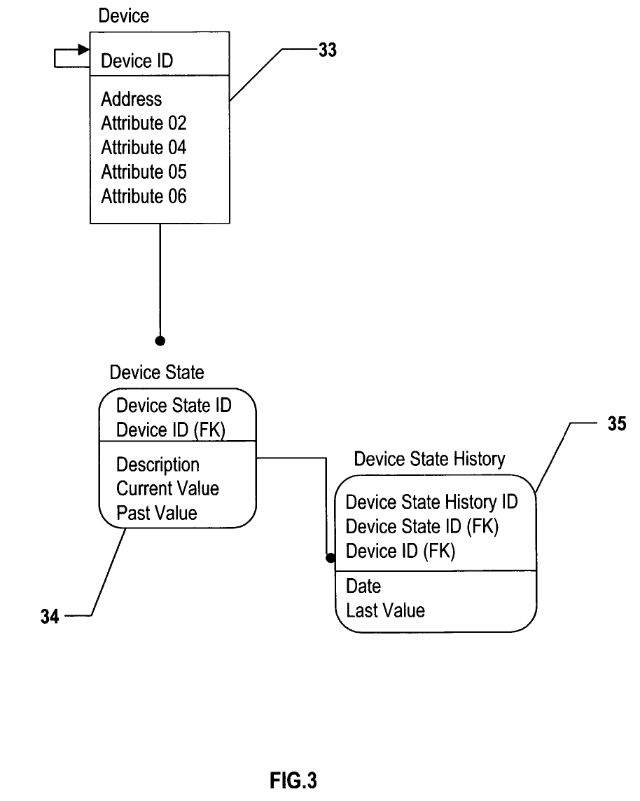

FIG. 3 illustrates a process and data flow model of a device state management system of the present invention. It maintains state (status) information of all devices, sensor and components that it can communicate on the system. This model provides the basis and core of sub systems status (state), transition and event driven based decision-making operation. It maintains current status of devices and it's past state history. It also offers the capacity to reset status in the event of an interruption in power or reversing an updating entry. The names chosen in this model exemplify distinctly what the process flow represents. Regardless, if the entities and its attributes are renamed or represented in a de-normalized fashion. The effect of the model is the same. The device 33 comprises attributes that define it current data values, and primary event driven operations. Devices can also be an aggregation of smaller devices (i.e. sensors, components, etc.) The device has a Unique Identifier and sensor(s) or component(s) that are aggregated make up that device [i.e. a thermal sensor, and a Thermostat (consists of thermal sensor, LED display etc.) are both considered devices. Though one attribute may be part of the composition of another.] The device state 34 represents current status configuration of the device. This device state comprises: 1) Device State ID—Unique identifier of the specific status state it references, 2) Description—Clear Definition of the State that is identified by the Device State ID, 3) Current Value—Current Status value of the device and 4) Past Value—Previous Status value of the device. The Device State History 35 contains the history of pass values per device which include: 1) Date—Date of historical record and 2) Last Value—last value recorded on that date

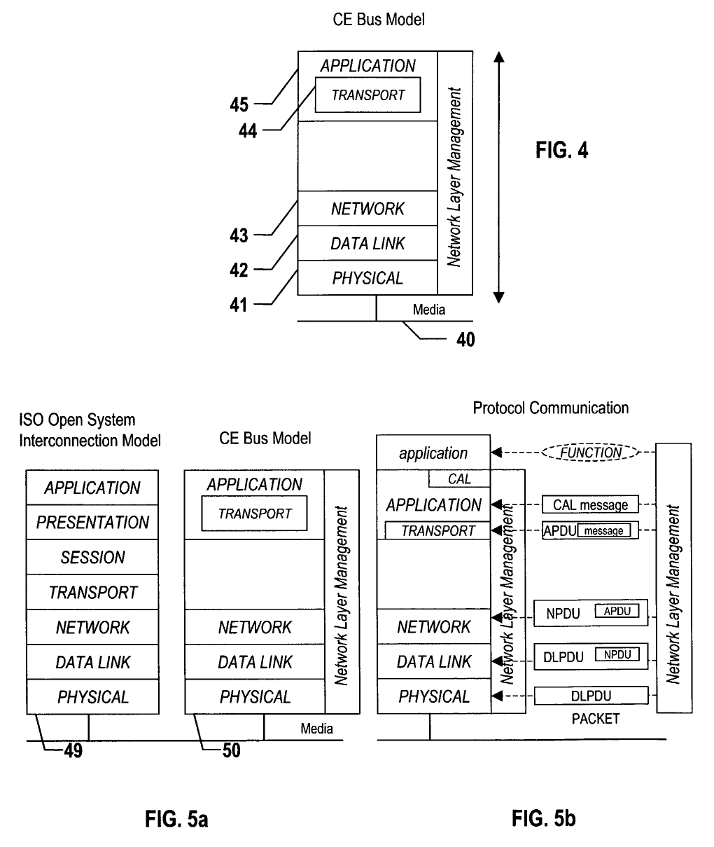

FIG. 4 is an illustration for the purpose of example of the Consumer Electronic Bus) CEBus Layered Model. It is a standard, much like the OSI (Open Systems Interconnection) Model, in that it illustrates the layer of communication from the physical layer (via physical connection to a media source) up the logical layers above the previous layer (via the network management) to the top level application layer into an application that makes sense of the information being transferred. Smart embedded devices in the Consumer Electronic Industry follow this standard. In fact many devices do not need to contain all logical levels within themselves within a single chip or component. The different required layers can span over components before the physical layer connects to a network medium.

At the core of the standard are the CAL and the Application Layer. It provides the basis of the interoperability between CEBus compliant devices and the transport independent version (Generic CALO ANSI/EIA 739 that is an integral part of the Home PnP (Plug and Play) ANSI/EIA 721 specification (which defines hoe networked products of various manufactures achieve interoperability regardless of the communication protocol used (CEBus, X-10, RS-232, IEEE-1394, TCP/IP etc.).

In this model, shown in FIG. 4, media 40 represents the wiring going out from the model. The physical layer 41 is the connection of a device to an electronic network. The data link layer 42, network layer 43, transport layer 44 and application layer 45 represent a standard of how information is communicated from a physical device down to logical data that is traced back to an application that talks to that model.

Many network applications can be maintained anywhere on the network, even remotely since the CEBus Model can share a common connection with the ISO across the same physical media. Regardless of the communication protocol used across the gateway, the receiving end needs only to understand the communication protocol and be able to interpret the data packets sent across the network. FIGS. 5a and 5b illustrate how communication can be bridged between the CEBus and the OSI Model, via a connected medium. The connected medium does not necessary have to be the same wire it can represent any other available connection means. These figures represent the two standard models interconnected, and communicating with each other. This illustrates how far reaching the scope of the state management is, and that it can incorporate any device that it has a connection to. The figure represents only two types of models, however the number of interconnected models, are not limited. It can involve any interconnections that can be accomplished between different models and their supported interconnected networks.

In FIG. 5a, the ISO System model 49 represents a conventional standard for communication. This model has seven different layers of communication. The CEBus model 50 has a different layer structure than the ISO model. However, down at the physical layer, the models are the same. The common physical layer provides the common interface for the models to communicate with each other through the media.

FIG. 5b shows the internal structure of the CEBus model. In this configuration information comes into the model through the different layers. The Common Application Language (CAL) is an interpreter that parses information and data, coming into the model, to appropriate applications and enables those applications to use that data. This diagram shows how information can go from a physical to a logical type of interpretation.

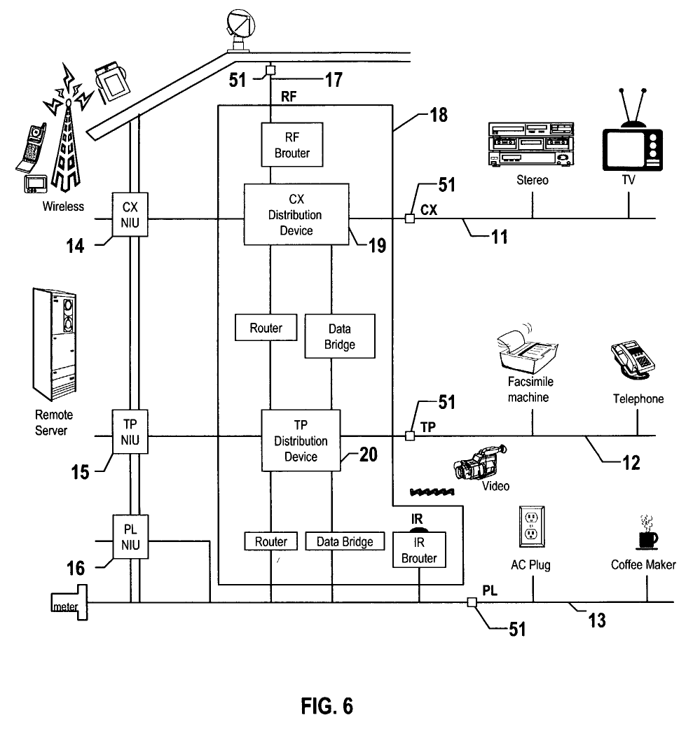

FIG. 6 illustrates the system of the present invention applied to a physical facility as shown in FIG. 1. Data can enter the network and be transmitted through the coaxial cable 11, twisted pairs 12, power lines 13 or radio frequency 17 mediums. Conversion nodes 51 provide bi-directional data conversion of messages into the appropriate communication protocol for of the receiving device. Within these conversion nodes are routines that match the communication protocol format of the transmitted message with the routine that converts that format into the CEBus protocol format when messages are transmitted to the state manager 18. The conversion routines are for common communication protocols such as X-10, RS-232, IEEE-1934, and TCP/IP. When messages are sent from the state manager 18, the conversion nodes transforms the CEBus format of the state manager into appropriate format of the receiving device.

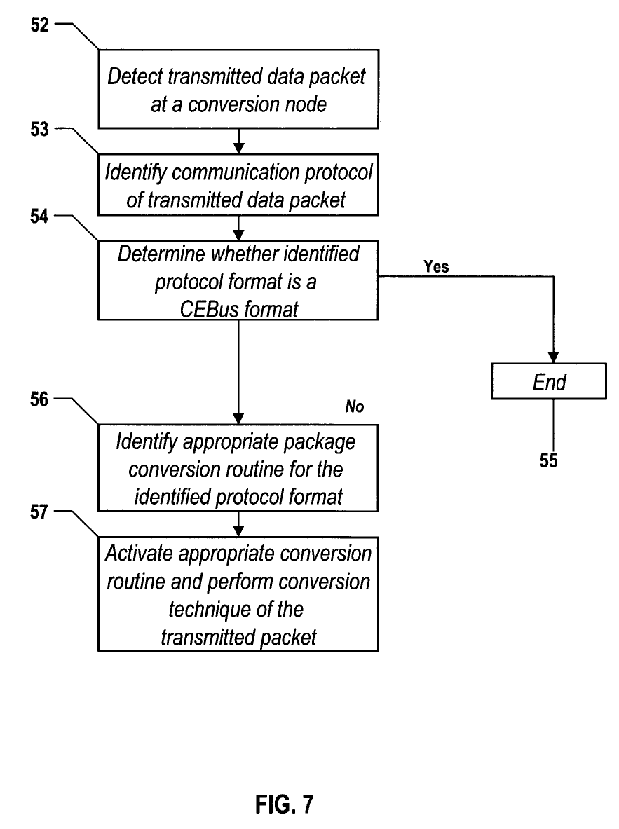

FIG. 7 illustrates the steps involved in the conversion method of the present invention. In step 52, a transmitted message is detected at the conversion node. The message communication protocol is then identified in step 53. This identification occurs by reading the header of the detected message. The message header will contain the communication protocol format of the message. At this point, in step 54, there is a determination whether the communication format of the transmitted message is the CEBus format. The transmitted message is the CEBus format, then it is not necessary to perform any conversion of the transmitted message and the conversion routine terminates in step 55. If in step 54, there is a determination that a message conversion is necessary, then step 56 identifies the appropriate conversion routine for that message format. Step 57 activates the conversion routine and the message conversion is performed by that routine.

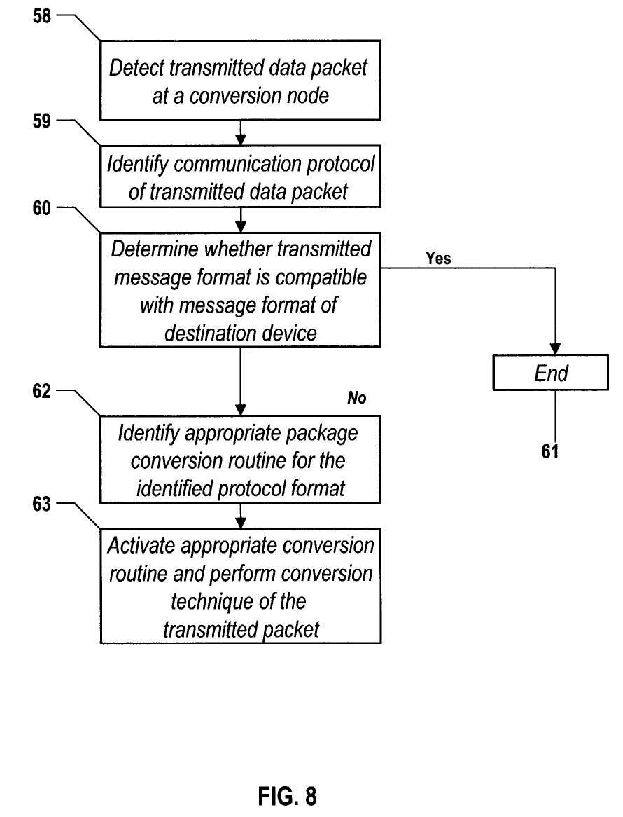

The message conversion method shown in FIG. 8 is the similar to the method in FIG. 7 when the transmitted message comes from the state manager in the CEBus format and has a destination device that has a format that is not the CEBus format. In step 58, a transmitted message is detected at the conversion node. The message communication protocol is then identified in step 59. Based on the message destination device, step 60 determines whether the communication format of the transmitted message is compatible with the communication format of the destination device. Since the transmitted messages will be mainly if not solely from the state manager 18 and therefore will have a CEBus format, message transmitted from the central manger can contain a header field with the message format of the destination device of the message. Device communication format information can be sent to the state manager 18 when a device initially connects to the network. If the transmitted message is in the CEBus format, then it is not necessary to perform any conversion of the transmitted message and the conversion routine terminates in step 61. If in step 60, there is a determination that a message conversion is necessary, then step 62 identifies the appropriate conversion routine for that message format. Step 63 activates the conversion routine and the message conversion is performed by that routine.

The present invention can be implemented in the context of the system described in a co-pending patent application number AUS920020055US1 assigned to the same assignee as the present invention, the contents of which are incorporated by reference herein. Although the present invention described in this context, this description is in no way limited by this specific application of the present invention. It is important to note that while the present invention has been described in the context of a fully functioning data communication system, those skilled in the art will appreciate that the processes of the present invention are capable of being distributed in the form of instructions in a computer readable medium and a variety of other forms, regardless of the particular type of medium used to carry out the distribution. Examples of computer readable media include media such as EPROM, ROM, tape, paper, floppy disc, hard disk drive, RAM, and CD-ROMs and transmission-type of media, such as digital and analog communications links.

We claim:

1. A method for converting messages in a pervasive embedded network environment from one communication protocol format to another communication protocol format comprising the steps of:
detecting the transmission of a message on a network;
identifying the communication protocol format of the transmitted message;
determining the compatibility between the communication protocol formats of the message sender and the message receiver;
identifying an appropriate communication protocol conversion routine, when the determination is that the communication formats are not compatible; and
performing the message conversion procedure with the appropriate communication protocol.

2. The method as described in claim 1 further comprising after said message conversion step, the step of transmitting the converted message to the destination location.

3. The method as described in claim 1 wherein said message format identifying step further comprising the step of reading the message header of the transmitted to gather information about the communication protocol format of the message.

4. The method as described in claim 1 wherein said compatibility determination step comprises comparing the message formats of the sending and receiving formats.

5. The method as described in claim 1 wherein said conversion routine identification step further comprises the step of matching the format of the sender with the format of the receiver.

6. A computer program product in a computer readable medium for converting messages in a pervasive embedded network environment from one communication protocol format to another communication protocol format comprising:
instructions for detecting the transmission of a message on a network;
instructions for identifying the communication protocol format of the transmitted message;
instructions for determining the compatibility between the communication protocol formats of the message sender and the message receiver;
instructions for identifying an appropriate communication protocol conversion routine, when the determination is that the communication formats are not compatible; and
instructions for performing the message conversion procedure with the appropriate communication protocol.

7. The computer program product as described in claim 6 further comprising after said message conversion instructions, instructions for transmitting the converted message the destination location.

8. The computer program product as described in claim 6 wherein said message format identifying instructions further comprise instructions for reading the message header of the transmitted to gather information about the communication protocol format of the message.

9 The computer program product as described in claim 6 wherein said compatibility determination instructions further comprise instructions for comparing the message formats of the sending and receiving formats.

10. The computer program product as described in claim 6 wherein said conversion routine identification instructions further comprise instructions for matching the format of the sender with the format of the receiver.

11. A system for converting messages in a pervasive embedded network environment from one communication protocol format to another communication protocol format comprising:
a plurality of devices capable of operating in multiple states;
a centralized status manager capable of receiving status information from said plurality of devices and transmitting information to the plurality of devices;
a system of communication links to connect said plurality of devices to said centralized status manager; and
a plurality of conversion nodes capable of detecting transmitted messages with communication formats that are different from the communication formats of the message destination location and converting the different message formats to a common format for message transmission.

12. The system as described in claim 11 wherein each conversion node of said plurality of conversion nodes contains a set of data format conversion routines that can convert messages of one format to another specified format.

13. The system as described in claim II wherein said communication link is a communication bus.

14. The system as described in claim 13 wherein said communication bus has a CEBus communication protocol.

15. The system as described in claim 11 wherein said plurality of communication nodes are positioned on said communication links.

16. The system as described in claim 11 wherein the environment in which said message conversion from one communication protocol format to another communication protocol format system occurs is a network that monitors and manages the statuses of devices that are connected to and operate on that network.

17. The system as described in claim 16 wherein the statuses of devices is monitored and managed from said central status manager.

18. A method for converting messages in a pervasive embedded network environment from one communication protocol format to another communication protocol format for message transmission in a network that monitors and manages the statuses of devices that are connected to and operate on that network comprising the steps of:
detecting the transmission of a message on a network;
identifying the communication protocol format of the transmitted message;
determining the compatibility between the communication protocol formats of the message sender and the message receiver;
identifying an appropriate communication protocol conversion routine, when the determination is that the communication formats are not compatible; and
performing the message conversion procedure with the appropriate communication protocol.

19. The method as described in claim 18 further comprising after said message conversion step, the step of transmitting the converted message to the destination location.

20. The method as described in claim 18 wherein said message format identifying step further comprising the step of reading the message header of the transmitted to gather information about the communication protocol format of the message.

21. The method as described in claim 18 wherein said compatibility determination step comprises comparing the message formats of the sending and receiving formats.

22. The method as described in claim 18 wherein said conversion routine identification step further comprises the step of matching the format of the sender with the format of the receiver.
